(19) United States
(12) Patent Application Publication
(10) Pub. No.: US 2007/0038630 A1
(43) Pub. Date: Feb. 15, 2007

(54) Method for generating a rights object, method and system for limiting a rights object

(76) Inventors: Yimin Li, Shenzhen (CN); Pei Dang, Shenzhen (CN)

Correspondence Address: MCANDREWS HELD & MALLOY, LTD, 500 WEST MADISON STREET, SUITE 3400, CHICAGO, IL, 60661, US

(21) Appl. No.: 11/503,663

(22) Filed: Aug. 14, 2006

(30) Foreign Application Priority Data
Aug. 15, 2005 (CN) 200510092508 X

(51) Int. Cl. G06F 17/30

(52) U.S. Cl. 707/9

(57) ABSTRACT

Discloses are a method for generating a rights object, and a method and apparatus for limiting a rights object. The method for generating a rights object includes: after the rights issuance system receives the rights information relative to the content object, the rights issuance system determines whether the rights object to be generated is a stateful rights object and has copy export permission according to the rights information, and performs subsequent processes for generating the rights object if it is not a stateful rights object or does not have the copy export permission. The rights issuance system further determines whether the rights information includes state limitation information for the copy export permission when the rights object to be generated is a stateful rights object and has the copy export permission. If it does, perform subsequent processes for generating the rights object. Otherwise, abandon the generation of the rights object.

### RELATED APPLICATIONS

This patent application makes reference to, claims priority to and claims benefit from Chinese Patent Application No. 200510092508.X filed on Aug. 15, 2005, which is explicitly incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention relates to digital rights technologies in computer and communication fields, and more particularly to a method for generating a rights object, and a method and system for limiting a rights object.

With the development of the network, contents on the network are more and more abundant. In order to protect the contents, Digital Right Management (DRM) is more and more widely used. Since users often hold several devices supporting different DRM systems, for the purpose of convenience, the users can consume contents on different DRM systems by applying for the rights object only once.

Referring to FIG. 1, a DRM content service system provides content objects, and a rights issuance system generates a rights object according to the rights information relative to the content object ordered by the user. During or after the process of obtaining the content object by the user terminal, the rights object relative to the content object is transmitted to the user terminal. The user can consume the content on the terminal according to the rights object.

At present, the rights object with the copy export permission is proposed in the related art. For the rights object with the copy export permission, the user can copy and export it to other devices, for example non-OMA (Open Mobile Alliance) DRM system device, and then consume the content object in these devices according to the rights object. That is, such kind of rights object can be exported to other DRM system, and the original rights object is retained in the former device.

However, for a stateful rights object with constraints (such as the defined usage times or the accumulated usage time, etc. in the rights object), when the state information for the export permission is not compulsory, a rights object which can only be played for 3 times has the copy export permission but does not limit the export times. A user who purchases the rights object may export the rights object to another device supporting another DRM system and consume the relative contents according to the rights object. After the user plays the content thrice on the device, he can export the original rights object to the other device again and continuously consume the content since the original rights object does not limit the export times. Therefore, the user can consume the content for limitless times.

In the related art, even if the rights information received by the rights issuance system has the copy export permission but does not have export state limitation information, the rights issuance system also can generate a stateful rights object (sometimes referred to as “RO”) according to the rights information. Therefore, the user who purchases the content with the consumption limitation can consume the content for limitless times by using the copy export permission.

### BRIEF SUMMARY OF THE INVENTION

According to one aspect of the present invention, after a rights issuance system receives rights information relative to a content object, a method for generating a rights object includes the steps of: the rights issuance system determining whether the rights object to be generated is a stateful rights object and has copy export permission according to the rights information, and performing subsequent processes for generating the rights object if it is not a stateful rights object or does not have the copy export permission. The method further includes: determining whether the rights information includes state limitation information for the copy export permission when the rights object to be generated is a stateful rights object and has the copy export permission, if it does, performing subsequent processes for generating the rights object, otherwise, abandoning the generation of the rights object.

When the rights issuance system generates the stateful rights object with copy export permission according to the rights information in the subsequent processes, the state limitation information for the copy export permission should be described in the description of the rights object.

The rights issuance system receives the rights information relative to the content object from a content service system, or a user-subscribing interface provided by the rights issuance system, or a content subscribing system of a third party.

The state limitation information includes at least one of: relative time interval limitation, times limitation, and period limitation.

After determining to abandon the generation of the rights object, the rights issuance system sends a notification message to the rights information provider.

The reason for abandoning the generation of the rights object is specified in the notification message.

According to another aspect of the present invention, a method for limiting a rights object is proposed. When a terminal device performs a rights object export, the method determines whether the rights object export permission is exporting a stateful rights object by copy mode, and performs the rights object export if the rights object export permission is not exporting a stateful rights object by copy mode. The method then determines whether description of the rights object includes state limitation information for copy export permission when the rights object export permission is exporting a stateful rights object by copy mode, and if the description of the rights object includes the state limitation information for copy export limitation, the method decides subsequent processes according to the state limitation information, otherwise, rejects the rights object export.

According to another aspect of the present invention, a rights issuance system is provided. The system includes a receiving module, a rights object generation module and an export state logical control module. The receiving module is used to receive rights information relative to a content object. The rights object generation module is used to generate the rights object according to the rights information received by the receiving module. And the export state logical control module is used to notify the rights object generation module to abandon the generation of the rights object when, according to the rights information, determining that the rights object to be generated has copy export permission and is stateful rights object, and the rights information does not contain the state limitation information for the copy export permission.

According to another aspect of the present invention, a terminal device includes a digital rights management module for receiving and processing a rights object; an export module for exporting the rights object; and an export state control module for notifying the export module to reject a rights object export when detecting that a stateful rights object is to be exported by copy mode but the stateful rights object does not include state limitation for copy export permission.

According to the present invention, the stateful RO with copy export permission may be compulsorily required to limit the export state information, such as the export times or the export period, etc. For such stateful rights object with copy export permission, it may be avoided that the user consumes the content for limitless times by using the export permission.

### BRIEF DESCRIPTION OF SEVERAL VIEWS OF THE DRAWINGS

FIG. 1 is a schematic diagram showing a conventional digital rights management networking.

FIG. 2 is a flow chart for generating a rights object according to an embodiment of the present invention.

FIG. 3 is a structure schematic diagram of a rights issuance system according to an embodiment of the present invention.

FIG. 4 is a flow chart for exporting a rights object by a terminal device according to an embodiment of the present invention.

FIG. 5 is a structure schematic diagram of a terminal device according to an embodiment of the present invention.

FIG. 6 is a schematic diagram showing the networking of a rights issuance system and a terminal device according to an embodiment of the present invention.

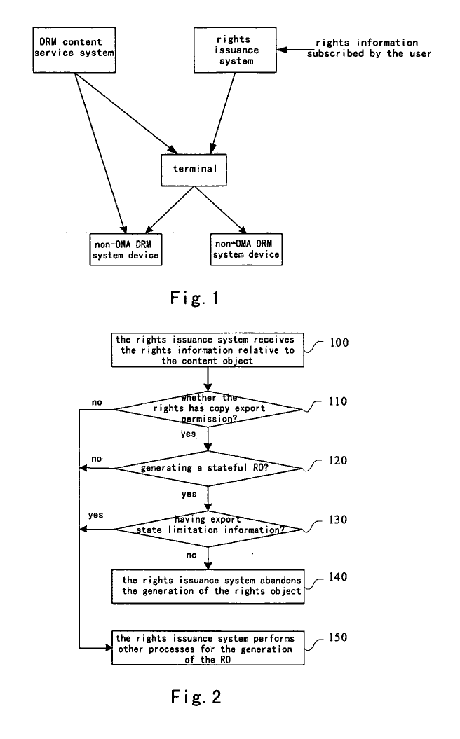

### DETAILED DESCRIPTION OF THE INVENTION

In the procedure of generating a rights object according to an embodiment of the present invention, the rights issuance system limits the export state information for generating the rights object (RO) with the state information of the copy export permission. The export state information includes a relative time interval limitation, a times limitation or a period limitation, etc. For example, the export times or the allowed export period can be limited in the state information.

In view of the rights object description grammar, compulsorily limiting the export state information for the stateful rights object with the copy export permission means that an optional limitation for the export state information is changed to a necessary limitation (such as the export times or allowed export period should be limited), when the copy export permission is needed to be specified in a stateful rights object. For example, if the user wants to purchase a rights object which can be played thrice and has the copy export permission, the rights object should have the limitation for the export times or the limitation for the allowed export period. Taking the limitation for the export times as an example, the segments of the rights object can be described as follows.

<o-ex:permission>
<o-dd:play>
<o-ex:constraint>
<o-dd:count>3</o-dd:count>
</o-ex:constraint>
</o-dd:play>
<oma-dd:export oma-dd:mode=”copy”>
<o-ex:constraint>
<oma-dd:system>
<o-ex:context>
<o-dd:version>1.0</o-dd:version>
<o-dd:uid>XYZ</o-dd:uid>
</o-ex:context>
</oma-dd:system>
<o-dd:count>3</o-dd:count>
</o-ex:constraint>
</oma-dd:export>
</o-ex:permission>

For the rights object with the copy export permission, the limitation of the stateful rights object must be performed for the copy export permission. Therefore, when the rights issuance system (sometimes referred to as “Rights Issuer” or “RI”) judges the validity of the rights information, it could check the copy export state information for the stateful rights object additionally.

Referring to FIG. 2, after the user selects an interested content on the DRM content service system and determines the information for purchasing the relative rights object, the flow that the rights issuance system processes the rights information relative to the content object includes the following steps.

In step 100, the rights issuance system (RI) receives the rights information relative to the content object, i.e., the rights information subscribed by the user.

The rights issuance system can receive the rights information from the content service system, or the user-subscribing interface provided by the rights issuance system, or the content subscribing system of the third party.

In step 110, the rights issuance system (RI) judges whether the rights object to be generated has the copy export permission. If yes, the procedure proceeds to step 120, otherwise, the procedure proceeds to step 150.

In step 120, the rights issuance system (RI) judges whether the rights object to be generated is a stateful rights object, i.e., whether the received rights information includes the relative time interval limitation, the times limitation, or the period limitation, etc. If yes, the procedure proceeds to step 130, otherwise, the procedure proceeds to step 150.

In step 130, the rights issuance system (RI) judges whether the received rights information includes the export state limitation information of the copy export permission, such as whether it includes the times limitation or period limitation, etc. If yes, the procedure proceeds to step 150, otherwise, the procedure proceeds to step 140.

In step 140, the rights issuance system (RI) determines that the rights object is not valid and abandons the generation of the rights object.

After abandoning the generation of the rights object, the rights issuance system returns a notification message which includes the reason for abandoning the generation of the rights object to the rights information provider.

In step 150, the rights issuance system (RI) continues the subsequent processes for generating the rights object, for example, other check processes (such as the grammar check for other permission) of the rights information are performed to realize the generation of the rights object. When the rights issuance system generates the stateful rights object with the copy export permission according to the rights information, the state limitation information for the copy export permission should be described in the descriptions of the rights object.

In the above flow, the processes from step 110 to 140 can be performed at any stage during the procedure from receiving the rights information to realizing the generation of the rights object by the rights issuance system, such as they can be performed before or after other validity check, which will not affect the realization of the present invention.

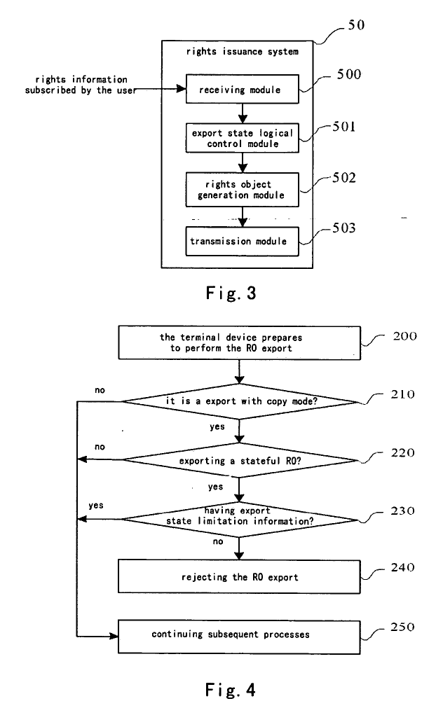

Referring to FIG. 3, the rights issuance system 50 used to achieve the above method includes a receiving module 500, an export state logical control module 501, a rights object generation module 502 and a transmission module 503.

The receiving module 500 receives the rights information relative to the content object.

The export state logical control module 501 has a logical connection relation with the receiving module 500, and is configured to judge whether the stateful rights object with the copy export permission needs to be generated according to the rights information received by the receiving module 500. If the rights information does not contain the export state limitation information for the copy export permission, the export state logical control module 501 notifies the rights object generation module 502 to abandon the generation of the rights object.

The rights object generation module 502 performs the validity check for the rights information, and finally generates the rights object according to the step 150 if the validity check is successful.

The transmission module 503 sends the rights object generated by the rights object generation module 502 to the terminal device for the consumption of the relative content according to the judgment of the export state logical control module 501.

In a preferable embodiment, the export state logical control module 501 is set in the rights object generation module 502, whereby the export state logical control module 501 and the rights object generation module 502 interact through interior interfaces.

Of course, the function module for performing the validity check in the rights object generation module 502 can be set outside the rights object generation module 502.

Referring to FIG. 4, the procedure that the terminal device exports the rights object includes the following steps.

In step 200, an export command is executed on the terminal device and the terminal device prepares to export the rights object to other device.

In step 210, the terminal device judges whether the operation is a copy export rights object operation. If yes, the procedure proceeds to step 220, otherwise, the procedure proceeds to step 250.

In step 220, the terminal device judges whether the rights object to be exported is a stateful rights object. If yes, the procedure proceeds to step 230, otherwise, the procedure proceeds to step 250.

In step 230, the terminal device judges whether the description of the rights object includes the state limitation information for the copy export permission. If no, the procedure proceeds to step 240, otherwise, the procedure proceeds to step 250.

In step 240, the terminal device determines that the copy export operation is not valid and rejects to perform the rights object export operation.

After the export operation is rejected, a notification message can be sent to the user.

In step 250, subsequent processes of the export operation are performed. In the case of exporting the stateful rights object by copy mode and the state limitation information for the copy export permission, the terminal device determines whether the operation is performed according to the state limitation information. For example, if the number of the copy export times is limited to three and the current export process is the forth time, the current export process will be rejected.

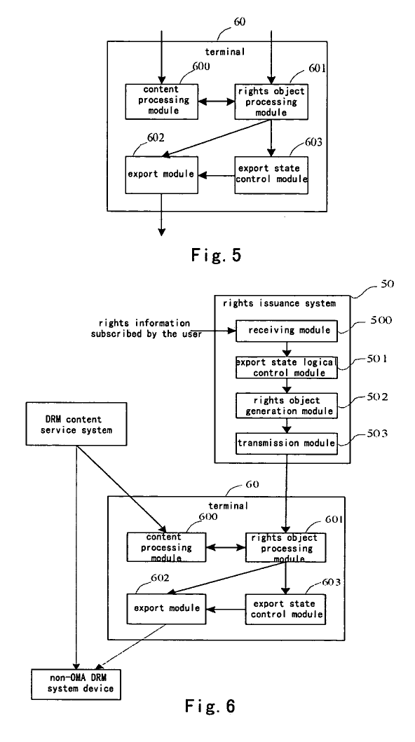

A terminal device is provided by the present application accordingly. Referring to FIG. 5, the terminal device includes a content processing module 600, a rights object processing module 601, an export state control module 602 and an export module 603.

The content processing module 600 receives and processes the content object.

The rights object processing module 601 has a logical connection relation with the content processing module 600, and is configured to receive the rights object from the rights issuance system and control the content process of the content processing module 600 according to the permissions in the RO.

The export state control module 602 has a logical connection relation with the export module 603, and is used to detect the type of the export processing, the RO type and the copy export state limitation information, and notify the export module 603 to reject the export processing when the RO to be exported is a stateful RO with copy export permission and there are not stateful rights object state limitations for the copy export permission.

The export module 603 has a logical connection relation with the rights object processing module 601 and the export state control module 602, and is configured to export the rights object to other device.

In a preferable embodiment, the export state control module 602 is set in the export module 603.

As shown in FIG. 6, the whole procedure for using the DRM content includes the following steps when adopting the present invention.

Step 1. The user selects an interested content on the DRM content service system and determines the information for purchasing the relative rights object, and the information includes the copy export permission and usage times.

Step 2. The rights issuance system (RI) receives the rights information subscribed by the user from the content service system (or the user-subscribing interface provided by RI, or the content subscribing system of the third party).

Step 3. The rights issuance system (RI) judges the export state logic for the rights information.

Step 4. The rights issuance system (RI) determines that the rights information is right and then generates the corresponding rights object.

Step 5. The user terminal receives the content and rights object from the content service system and RI respectively, in which the content can be transferred through other user terminal.

Step 6. The terminal exports the rights object to other DRM system device through the export module and limits the total export times or total export period for the stateful rights object to ensure that the rights object will not be exported for limitless times.

Step 7. The destination DRM system device receives the content from the content service system or other user terminal and consumes the content according to the exported rights object.

Though illustration and description of the present invention have been given with reference to preferred embodiments thereof, it should be appreciated by ordinary personnel skilled in the art that various changes in forms and details can be made without deviation from the spirit and scope of this invention as defined by the appended claims.

What is claimed is:

1. A method for generating a rights object after a rights issuance system receives rights information relative to a content object, comprising:
determining by the rights issuance system whether the rights object to be generated is a stateful rights object and has copy export permission according to the rights information, and performing subsequent processes for generating the rights object if it is not a stateful rights object or does not have the copy export permission; and
determining whether the rights information comprises state limitation information for the copy export permission when the rights object to be generated is a stateful rights object and has the copy export permission, and performing subsequent processes for generating the rights object if the rights information comprises the state limitation information for the copy export permission, otherwise, abandoning the generation of the rights object.

2. The method according to claim 1, wherein,
when the rights issuance system generates the stateful rights object with the copy export permission according to the rights information in the subsequent processes, the state limitation information for the copy export permission is described in the description of the rights object.

3. The method according to claim 1, wherein,
the rights issuance system receives the rights information relative to the content object from a content service system, or an user-subscribing interface provided by the rights issuance system, or a content subscribing system of a third party.

4. The method according to claim 1, wherein,
the state limitation information comprises at least one limitation selected from the group consisting of relative time interval limitation, times limitation, and period limitation.

5. The method according to claim 1, wherein,
after determining to abandon the generation of the rights object, the rights issuance system sends a notification message to the rights information provider.

6. The method according to claim 2, wherein,
after determining to abandon the generation of the rights object, the rights issuance system sends a notification message to the rights information provider.

7. The method according to claim 3, wherein,
after determining to abandon the generation of the rights object, the rights issuance system sends a notification message to the rights information provider.

8. The method according to claim 4, wherein,
after determining to abandon the generation of the rights object, the rights issuance system sends a notification message to the rights information provider.

9. The method according to claim 8, wherein,
the reason for abandoning the generation of the rights object is specified in the notification message.

10. The method according to claim 7, wherein,
the reason for abandoning the generation of the rights object is specified in the notification message.

11. The method according to claim 6, wherein,
the reason for abandoning the generation of the rights object is specified in the notification message.

12. The method according to claim 5, wherein,
the reason for abandoning the generation of the rights object is specified in the notification message.

13. A method for limiting a rights object, comprising:
determining whether a rights object export permission is exporting a stateful rights object by copy mode, and performing the rights object export if the rights object export permission is not exporting a stateful rights object by copy mode; and
determining whether description of a rights object comprises state limitation information for copy export permission when the rights object export permission is exporting a stateful rights object by copy mode, and if the description of the rights object comprises the state limitation information for copy export limitation, performing subsequent processes according to the state limitation information, otherwise, rejecting the rights object export.

14. The method according to claim 13, wherein,
the state limitation information comprises at least one limitation selected from the group consisting of relative time interval limitation, times limitation, and period limitation.

15. The method according to claim 13, wherein,
a terminal device notifies the corresponding user that the rights object export is rejected.

16. The method according to claim 14, wherein,
a terminal device notifies the corresponding user that the rights object export is rejected.

17. A rights issuance system, comprising:
a receiving module configured to receive rights information relative to a content object;
a rights object generation module configured to generate the rights object according to the rights information received by the receiving module; and
an export state logical control module configured to notify the rights object generation module to abandon the generation of the rights object when, according to the rights information, determining that the rights object to be generated has copy export permission and is stateful rights object, and the rights information does not contain the state limitation information for the copy export permission.

18. The rights issuance system according to claim 17, wherein,
the export state logical control module is set in the rights object generation module.

19. A terminal device, comprising:
a digital rights management module configured to receive and processing a rights object;
an export module configured to export the rights object; and
an export state control module configured to notify the export module to reject a rights object export when detecting that a stateful rights object is to be exported by copy mode but the stateful rights object does not comprise state limitation for copy export permission.

20. The terminal device according to claim 19, wherein, the export state control module is set in the export module.
